(19) United States
(12) Patent Application Publication
(10) Pub. No.: US 2026/0044049 A1
(43) Pub. Date: Feb. 12, 2026

(54) SYSTEMS AND METHODS FOR CONTROLLING RESPONSE TIMES FOR ALL-OPTICAL SWITCHES

(71) Applicant: UCHICAGO ARGONNE, LLC, Chicago, IL (US)

(72) Inventors: Soham Saha, Westmont, IL (US); Richard D. Schaller, Clarendon Hills, IL (US); Benjamin Diroll, Chicago, IL (US)

(21) Appl. No.: 19/291,760

(22) Filed: Aug. 6, 2025

Related U.S. Application Data
(60) Provisional application No. 63/679,984, filed on Aug. 6, 2024.

(51) Int. Cl. G02F 1/35

(52) U.S. Cl. CPC G02F 1/3515

(57) ABSTRACT

Systems and methods for controlling response times of an all-optical switch are disclosed herein. An example method includes pumping an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment. The example method further includes adjusting one or more of the optical characteristics of the pump beam to cause the pump beam to excite a second set of materials of the plurality of materials that is different from the first set of materials; and pumping the all-optical switch with the adjusted pump beam to induce the adjustment to the probe beam in a second response time.

### CROSS-REFERENCE TO RELATED APPLICATIONS

This application claims priority to U.S. Provisional Application No. 63/679,984 filed on Aug. 6, 2024, entitled “Systems and Methods for Controlling Response Times for All-Optical Switches,” the entire contents of which are hereby expressly incorporated herein by reference.

### TECHNICAL FIELD

The present disclosure generally relates to controlling response times in all-optical switches, and more particularly, to techniques involving the adjustment of optical characteristics of pump and probe beams to manipulate the response times of the switches, such as adjusting the wavelength, incidence angle, or polarization of the beams.

### BACKGROUND

All-optical switches control the amplitude, phase, and polarization of light using optical control pulses. They can operate at ultrafast timescales, which is essential for technology-driven applications like optical computing and fundamental studies like time-reflection. However, conventional all-optical switches experience several notable drawbacks.

Conventional all-optical switches are generally fabricated to operate at fixed speeds and wavelengths, determined by the intrinsic properties of the materials used and the design of the switch. This inherent limitation restricts the flexibility and adaptability of optical communication systems, especially in dynamic environments where the ability to adjust operational parameters such as switching speed in real-time could significantly enhance performance and efficiency. Moreover, conventional all-optical switches do not readily allow for the investigation or manipulation of carrier dynamics within the switch materials themselves, further limiting the potential for optimization and control in optical networks.

Integrating multiple materials with varying optical properties and switching response times into the design of optical switches has been explored as a means to extend the functionality and operational bandwidth of these devices. However, challenges remain in effectively harnessing the diverse response characteristics of these materials to achieve tunable switch performance. Specifically, the interaction between the pump (or probe) light and the material layers within a switch, and how this interaction can be modulated through changes in wavelength, angle, and polarization to control the switch's response time, is an area of ongoing research. Existing approaches often fail to offer a comprehensive solution that enables real-time, adjustable control over the switch's operational parameters, limiting the versatility and application potential of optical switching technologies.

Given these challenges, there are clear opportunities for the development of improved techniques that address the limitations of conventional optical switching mechanisms.

### SUMMARY

In some aspects, the techniques described herein relate to a method for controlling response times of an all-optical switch including: pumping an all-optical switch with a pump beam to induce an adjustment to a probe beam in a first response time, the all-optical switch including a plurality of materials that each have a respective response time, and the pump beam having optical characteristics configured to cause the pump beam to excite a first set of materials of the plurality of materials to induce the adjustment; adjusting one or more of the optical characteristics of the pump beam to cause the pump beam to excite a second set of materials of the plurality of materials that is different from the first set of materials; and pumping the all-optical switch with the adjusted pump beam to induce the adjustment to the probe beam in a second response time.

In some aspects, the techniques described herein relate to a method, wherein adjusting the one or more of the optical characteristics of the pump beam further includes: adjusting one or more of: (i) a wavelength of the pump beam, (ii) an incidence angle of the pump beam, or (iii) a polarization of the pump beam.

In some aspects, the techniques described herein relate to a method, wherein the wavelength of the pump beam ranges from approximately 325 nanometers (nm) to approximately 1400 nm.

In some aspects, the techniques described herein relate to a method, wherein each material of the plurality of materials has a respective resonant frequency, and wherein adjusting the one or more of the optical characteristics of the pump beam further includes: adjusting a wavelength of the pump beam to the respective resonant frequency of the second set of materials.

In some aspects, the techniques described herein relate to a method, wherein the first response time is approximately 10 nanoseconds and the second response time is approximately 500 femtoseconds.

In some aspects, the techniques described herein relate to a method, wherein the plurality of materials includes a layer of Aluminum-doped Zinc Oxide (AZO) having a thickness of approximately 250 nm and a layer of Titanium Nitride (TiN) having a thickness of approximately 130 nm.

In some aspects, the techniques described herein relate to a method, wherein the plurality of materials includes three or more materials.

In some aspects, the techniques described herein relate to a method, further including: adjusting one or more optical characteristics of the probe beam to cause the probe beam to excite the second set of materials.

In some aspects, the techniques described herein relate to a method, wherein adjusting the one or more optical characteristics of the probe beam further includes: adjusting one or more of: (i) a wavelength of the probe beam, (ii) an incidence angle of the probe beam, or (iii) a polarization of the probe beam.

In some aspects, the techniques described herein relate to a method, wherein the plurality of materials includes at least a first layer and a second layer, and wherein the first layer or the second layer is included of one or more of: (i) AZO, (ii) TiN, (iii) Indium Tin Oxide (ITO), (iv) Indium Zinc Oxide (IZO), (v) an amorphous form of Indium Zinc Tin Oxide (IZTO), (vi) a crystalline form of IZTO, or (vii) Indium (III) Oxide (In₂O₃).

In some aspects, the techniques described herein relate to a method, wherein the all-optical switch at least partially includes an optical system that is configured to at least partially perform at least one of: (i) signal routing, (ii) signal processing, or (iii) logic operations within a communications system.

In some aspects, the techniques described herein relate to a method, wherein the wavelength of the pump beam or the probe beam ranges from approximately 325 nm to approximately 35 μm.

In some aspects, the techniques described herein relate to a computer system for controlling response times of an all-optical switch, the computer system including: one or more processors; and a non-transitory computer-readable medium storing thereon instructions that, when executed by the one or more processors, cause the computer system to: pump an all-optical switch with a pump beam to induce an adjustment to a probe beam in a first response time, the all-optical switch including a plurality of materials that each have a respective response time, and the pump beam having optical characteristics configured to cause the pump beam to excite a first set of materials of the plurality of materials to induce the adjustment, adjust one or more of the optical characteristics of the pump beam to cause the pump beam to excite a second set of materials of the plurality of materials that is different from the first set of materials, and pump the all-optical switch with the adjusted pump beam to induce the adjustment to the probe beam in a second response time.

In some aspects, the techniques described herein relate to a computer system, wherein the instructions, when executed by the one or more processors, further cause the computer system to adjust the one or more of the optical characteristics of the pump beam by: adjusting one or more of: (i) a wavelength of the pump beam, (ii) an incidence angle of the pump beam, or (iii) a polarization of the pump beam, wherein the wavelength of the pump beam ranges from approximately 325 nanometers (nm) to approximately 1400 nm.

In some aspects, the techniques described herein relate to a computer system, wherein each material of the plurality of materials has a respective resonant frequency, and wherein the instructions, when executed by the one or more processors, further cause the computer system to adjust the one or more of the optical characteristics of the pump beam by: adjusting a wavelength of the pump beam to the respective resonant frequency of the second set of materials.

In some aspects, the techniques described herein relate to a computer system, wherein the first response time is approximately 10 nanoseconds and the second response time is approximately 500 femtoseconds.

In some aspects, the techniques described herein relate to a computer system, wherein the plurality of materials includes a layer of Aluminum-doped Zinc Oxide (AZO) having a thickness of approximately 250 nm and a layer of Titanium nitride (TiN) having a thickness of approximately 130 nm.

In some aspects, the techniques described herein relate to a computer system, wherein the plurality of materials includes three or more materials.

In some aspects, the techniques described herein relate to a computer system, wherein the instructions, when executed by the one or more processors, cause the computer system to: adjust one or more of: (i) a wavelength of the probe beam, (ii) an incidence angle of the probe beam, or (iii) a polarization of the probe beam to cause the probe beam to excite the second set of materials.

In some aspects, the techniques described herein relate to one or more non-transitory computer-readable storage media including instructions that, when executed by one or more processors, cause the one or more processors to: pump an all-optical switch with a pump beam to induce an adjustment to a probe beam in a first response time, the all-optical switch including a plurality of materials that each have a respective response time, and the pump beam having optical characteristics configured to cause the pump beam to excite a first set of materials of the plurality of materials to induce the adjustment; adjust one or more of the optical characteristics of the pump beam to cause the pump beam to excite a second set of materials of the plurality of materials that is different from the first set of materials; and pump the all-optical switch with the adjusted pump beam to induce the adjustment to the probe beam in a second response time . . .

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2 depicts a probe beam and a pump beam interacting with an example all-optical switch, in accordance with various embodiments described herein.

FIG. 3A depicts an example double-resonant two-layer optical switch device, in accordance with various embodiments described herein.

FIG. 3B depicts an example reflectance spectrum shifting resulting from pump interactions with an optical switch device, in accordance with various embodiments described herein.

FIG. 3C depicts example response time variations for a multi-layered optical switch device in response to interactions with a probe at different wavelengths, in accordance with various embodiments described herein.

FIG. 4A depicts an example two-layer TiN-AZO optical switch device, in accordance with various embodiments described herein.

FIG. 4B depicts example reflectance spectra for s-polarized and p-polarized light interacting with an all-optical switch device, in accordance with various embodiments described herein.

FIG. 4C depicts example absorption spectra for p-polarized light interacting with an all-optical switch device, in accordance with various embodiments described herein.

FIG. 4D depicts the femtosecond response time of an all-optical switch device based on pump wavelength, in accordance with various embodiments described herein.

FIG. 4E depicts an example transient modulation response of an all-optical switch device in relation to probe wavelength, in accordance with various embodiments described herein.

FIG. 4F depicts an example multi-material all-optical switch device comprising individual layers of different shapes/dimensions, in accordance with various embodiments described herein.

FIG. 4G depicts example permittivity response curves of an optical switch device in relation to probe wavelength, in accordance with various embodiments described herein.

FIG. 4H depicts example recombination time variations for optical switch devices comprised of various materials, in accordance with various embodiments described herein.

FIG. 5 depicts a flow diagram representing an example computer-implemented method, in accordance with various embodiments described herein.

### DETAILED DESCRIPTION

The present techniques focus on systems and methods for controlling the response times of an all-optical switch, a device pivotal in the realm of optical computing and communication. This approach leverages the unique properties of a multi-material composition within the all-optical switch and the tunability of optical characteristics such as wavelength, incidence angle, and polarization of both pump and/or probe beams. By adjusting these characteristics, the present techniques can selectively excite different sets of materials within the switch, each possessing distinct resonant frequencies and response times. This selective excitation enables the modulation of the switch's response time, offering a dynamic range from nanoseconds to femtoseconds, thereby addressing the limitations of conventional all-optical switches which are typically fixed in their operational speed post-fabrication.

As an example, the systems and methods described herein may utilize a bi-material, multi-layer all-optical switch with at least one layer of AZO and at least one layer of TiN. This bi-material switch may generally have a nanosecond response when the pump/probe beam interacts strongly with the TiN layer near its epsilon-near-zero (ENZ) wavelength. The switch's response-time decreases by over two orders of magnitude with increasing pump/probe wavelength, as the incident light's degree of interaction with the faster AZO layer increases, eventually reaching the picosecond-scale near AZO's ENZ-regime. Thus, when coupled with the several additional degrees of freedom for switching time control, such as pump/probe polarization and incident angle, this bi-material, multi-layer all-optical switch enables new functionalities within key applications in, for example, multiband transmission, optical computing, and/or nonlinear optics.

Accordingly, a significant improvement introduced by the present techniques is the enhancement of processing speeds within optical computing systems. By enabling the control over the response time of the all-optical switch, these techniques facilitate the operation of optical systems at speeds ranging from tens of gigahertz to terahertz, surpassing the limitations imposed by Moore's Law in electronic systems. This is achieved through the methodical adjustment of the pump/probe beam's optical characteristics to excite specific materials within the switch, each contributing to the overall speed of the switching process based on their response times.

Another improvement is the optimization of network usage in optical communication systems. The ability to dynamically adjust the response time of all-optical switches allows for more efficient management of data traffic, reducing latency and improving bandwidth utilization. This is particularly beneficial in environments where data traffic can vary significantly, requiring adaptable systems that can swiftly adjust to changing demands without compromising on performance.

Furthermore, the present techniques contribute to improved memory usage in optical data storage and retrieval systems. By controlling the response time of all-optical switches, data can be written to and read from optical storage media at variable speeds, allowing for more efficient use of storage capacity and faster access times. This adaptability ensures that optical storage systems can meet the demands of high-speed data processing applications, where rapid access to large volumes of data is critical.

The method involves initially pumping the all-optical switch with a pump beam to induce an adjustment to a probe beam within a first response time. This process takes advantage of the switch's composition, which includes a plurality of materials each with a specific response time. The pump beam, with its tailored optical characteristics, excites a first set of materials, inducing the desired adjustment. Subsequently, by adjusting one or more optical characteristics of the pump beam, a second set of materials is excited, leading to an adjustment to the probe beam in a second, distinct response time. This dual-phase approach, coupled with the computer system's capability to precisely control the optical characteristics of the pump and probe beams, underscores the versatility and efficiency of the present techniques in managing the operational dynamics of all-optical switches.

In essence, the present techniques represent a significant advancement in the field of optical computing and communication, offering a flexible and efficient method for controlling the response times of all-optical switches. Through the strategic manipulation of optical characteristics and the utilization of multi-material compositions, these techniques pave the way for faster, more adaptable optical systems capable of meeting the evolving demands of modern computing and communication infrastructures.

Still further, the present disclosure includes specific features other than what is well-understood, routine, conventional activity in the field, or adding unconventional steps that demonstrate, in various embodiments, particular useful applications, e.g., pumping an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment; adjusting one or more of the optical characteristics of the pump beam to cause the pump beam to excite a second set of materials of the plurality of materials that is different from the first set of materials; and/or pumping the all-optical switch with the adjusted pump beam to induce the adjustment to the probe beam in a second response time, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

### Example Computing System

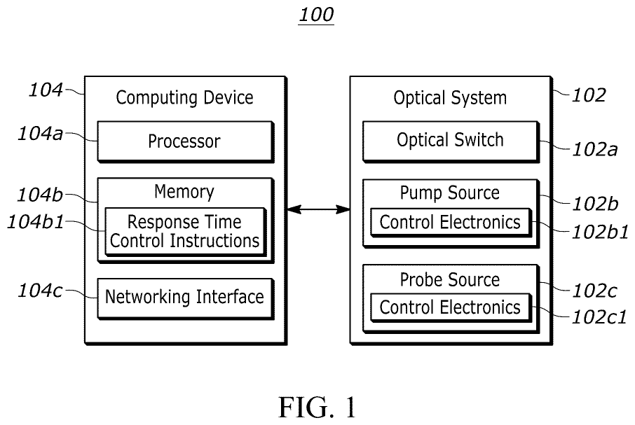

FIG. 1 depicts an example computing system 100 in which various embodiments of the present disclosure may be implemented. Depending on the embodiment, the example computing system 100 may adjust optical characteristics of a pump beam and/or a probe beam and/or perform any of the other actions/functions described herein. Of course, it should be appreciated that, while the various components of the example computing system 100 (e.g., computing device 104, optical system 102, etc.) are illustrated in FIG. 1 as single components, the example computing system 100 may include multiple (e.g., dozens, hundreds, thousands) of computing devices 104 and/or optical systems 102 that are simultaneously connected to one another and/or are otherwise configured to operate together.

Generally, the example computing system 100 includes an optical system 102 and a computing device 104. The computing device 104 may communicate with the optical system 102, and in certain embodiments, the computing device 104 may include the optical system 102. As an example, the computing device 104 may perform and/or oversee/regulate computing operations as part of an optical computing environment and the optical system 102 may be a set of hardware configured to route data, modulate signals, participate in logic operations and/or otherwise facilitate the optical computing operations performed therein.

More specifically, the optical system 102 includes an optical switch 102a, a pump source 102b, and a probe source 102c. Generally, the optical switch 102a is composed of materials that exhibit strong light-matter interactions and is configured to control the path of the probe beam emitted by the probe source 102c within a network or system based on the pump beam emitted by the pump source 102b. The pump beam emitted by the pump source 102b alters the optical properties of the optical switch 102a materials, such as the material refractive index, through mechanisms like the Kerr effect, photonic bandgap shifts, and/or carrier injection and depletion. In so doing, the pump beam induces (i.e., causes) the optical switch 102a to adjust an optical characteristics/property of the probe beam emitted by the probe source 102c. For example, the pump beam's interaction with the optical switch 102a can change the direction, phase, and/or intensity of the probe beam.

Accordingly, this capability enables the implementation of various functionalities in optical communication and computing systems, such as routing, signal processing, and logic operations, all at the speed of light and potentially with high bandwidth and low power consumption. In particular, in certain embodiments, the optical switch 102a may at least partially comprise the optical system 102, and the optical system 102 may be configured to at least partially perform at least one of signal routing, signal processing, and/or logic operations within a communications system (not shown). For example, the optical system 102 could be integrated into an optical network switch for data routing in a fiber-optic communication system. The pump source 102b may generate a pump beam that interacts with the optical switch 102a material to manipulate the properties of the probe beam emitted by the probe source 102c, effectively controlling the direction, phase, and/or intensity of the probe beam. This configuration could enable dynamic signal routing within the optical network, allowing for on-the-fly adjustments to accommodate changing communication demands. Additionally, or alternatively, the optical switch 102a could be used for signal processing tasks, such as signal regeneration or wavelength conversion, enhancing the efficiency and flexibility of the communication system. Furthermore, the inherent speed of light transmission in optical systems and the potential for high bandwidth and low power consumption make this implementation ideal for building fast and energy-efficient communication networks.

The materials generally composing the optical switch 102a can include semiconductors, nonlinear optical crystals, and/or composite materials designed to have specific optical properties, such as epsilon near zero (ENZ) conditions or resonances at particular wavelengths. For example, the optical switch 102a may be a multi-layer device that includes a layer of AZO and a separate layer of TiN, and these layers may be of any suitable thickness. Specifically, the AZO layer may have a thickness of approximately 250 nm and the TiN layer may have a thickness of approximately 130 nm. In some embodiments, the optical switch 102a may have three or more layers, and/or may generally have any suitable number of layers having any suitable organization, shape, and/or sequencing of materials.

In certain embodiments, the optical switch 102a is an all-optical switch, such that the switch 102a modulates and/or directs light signals without converting them to electrical signals. Additionally, in some embodiments, the optical switch 102a has a maximum response time of approximately 10 nanosecond and a minimum response time of approximately 500 femtoseconds. Of course, it should be appreciated that the maximum/minimum response time of the optical switch 102a may vary depending on the specific materials comprising the switch 102a, as well as the optical characteristics of the incident pump beam and/or probe beams.

The pump source 102b is generally configured to provide the optical energy (e.g., via light beam, pulses, etc.) required to activate or control the optical switch 102a. The pump source 102b emits light at a specific wavelength, intensity, and polarization, which interacts with the material of the optical switch 102a to induce changes in its optical properties, such as refractive index alterations. These changes enable the switch 102a to modulate, direct, or block the signal light (e.g., the probe beam) passing through it.

The pump source 102b may generally be a laser or light-emitting diode (LED) capable of producing coherent or incoherent light at the desired optical characteristics. The choice of laser or LED may depend on the required power levels, wavelength precision, and/or beam quality for effectively interacting with the optical switch 102a material(s). The pump source 102b may also be coupled with optical components (not shown) like lenses, waveguides, and/or fiber optics to precisely deliver the pump beam/light to the optical switch 102a. Additionally, the pump source 102b may include control electronics 102b1 for adjusting the output power, wavelength, modulation, and/or any other optical characteristics of the pump beam to achieve the desired switching behavior in the optical switch 102a. In certain embodiments, the wavelength of the pump beam ranges from approximately 325 nanometers nm to approximately 1400 nm.

The probe source 102c is generally configured to provide an optical signal that is to be switched, modulated, and/or otherwise adjusted by the optical switch 102a. This probe beam carries the information or data within an optical communication or computing system (e.g., computing system 100). The probe beam interacts with the optical switch 102a material, which is often excited and/or otherwise altered in its optical properties by the pump beam emitted from the pump source 102b. This interaction with the optical switch 102a material “adjusts” the probe beam by, for example, directing the probe beam along different paths, modulating the probe beam's intensity, and/or shifting the probe beam's phase, thereby achieving the desired switching action.

The probe source 102c is generally a light source that can generate light at the required wavelength, coherence, and/or power level for the specific application. Similar to the pump source 102b, the probe source 102c can be or include a laser, LED, and/or another suitable light source, depending on the optical system's 102 requirements for signal quality and interaction with the optical switch 102a material(s). The probe source 102c is often designed to be compatible with the optical properties of the optical switch 102a to ensure efficient coupling and minimal loss. The probe source 102c may also be coupled with optical components (not shown) such as lenses, waveguides, and/or optical fibers to guide the probe beam/light from the probe source 102c to the optical switch 102a with precise control over its direction and focus. Additionally, the probe source 102c may be equipped with control electronics 102cl to adjust its output characteristics, such as intensity modulation and/or wavelength tuning, to facilitate various operational modes of the optical switch 102a.

The computing device 104 includes one or more processors 104a, one or more memories 104b, and a networking interface 104c. The memory 104b stores executable instructions that are configured to, when executed by the one or more processors 104a, cause the one or more processors 104a to analyze data (e.g., pump adjustment data) received at the computing device 104 and output various values (e.g., optical characteristic adjustments, etc.). The one or more memories 104b store a set of response time control instructions 104b1 which may include such executable instructions, as well as other data. The one or more memories 104b may also store additional data and/or databases. It should be appreciated that the computing device 104 can include one or multiple computing devices that are co-located or distributed.

More specifically, the set of response time control instructions 104b1 is generally responsible for adjusting one or more optical characteristics of the pump beam emitted by the pump source 102c, such as its wavelength, incidence angle, and/or polarization. Based on the desired response time of the optical switch 102a, the set of response time control instructions 104b1 may output a set of control instructions that are transmitted to the control electronics 102b1 of the pump source 102b, which subsequently implement the adjustments necessary to the pump source 102b to cause the emitted pump beam to have the desired optical characteristics indicated by the set of control instructions. In certain embodiments, the set of response time control instructions 104b1 may also output sets of control instructions that are transmitted to the control electronics 102cl of the probe source 102c, which subsequently implement the adjustments necessary to the probe source 102c to cause the emitted probe beam to have the desired optical characteristics indicated by the set of control instructions.

More generally, the one or more processors 104a may include any suitable number of processors and/or processor types. For example, the processors 104a may include one or more CPUs and one or more graphics processing units (GPUs). Generally, the processors 104a may be configured to execute software instructions stored in the one or more memories 104b. The memories 104b may include one or more persistent memories (e.g., a hard drive and/or solid-state memory) and may store one or more applications, modules, instruction sets, and/or models, such as the set of response time control instructions 104b1.

The networking interface 104c may enable the computing device 104 to communicate with the optical system 102. The networking interface 104c may support wired or wireless communications, such as USB, Bluetooth, Wi-Fi Direct, Near Field Communication (NFC), etc. The networking interface 104c may also enable the computing device 104 to communicate with the optical system 102 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

In certain embodiments, the networking interface 104c enables the computing device 104 to communicate with the optical system 102 across a network (not shown). The network may be a single communication network or may include multiple communication networks of one or more types (e.g., one or more wired and/or PANs or LANs, and/or one or more WANs such as the Internet). In some embodiments, the network includes multiple, entirely distinct networks.

It will be understood that the above disclosure is one example and does not necessarily describe every possible embodiment. As such, it will be further understood that alternate embodiments may include fewer, alternate, and/or additional steps or elements.

### Example Optical Switches and Response Time Characteristics

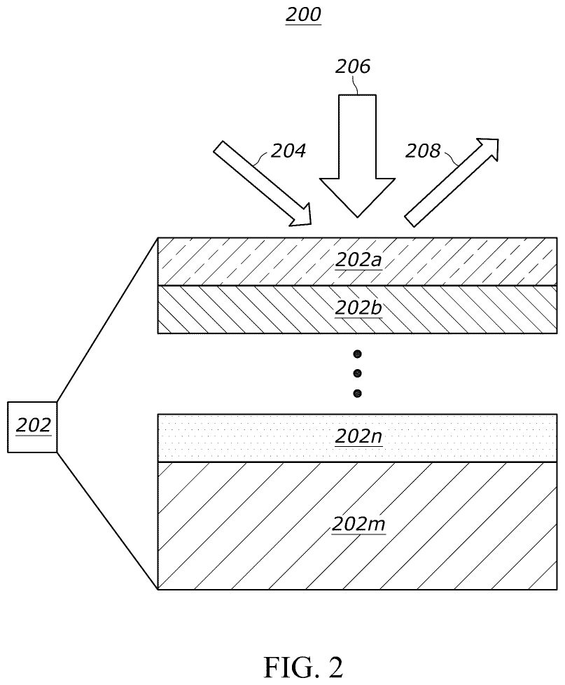

The following description in reference to FIGS. 2-4F provides several example optical switches, including their component materials and structures, as well as example optical probes and pumps, along with various physical and optical properties, interactions, and characteristics. It should be understood that these figures illustrate examples of optical responses that can result from variations in the composition and organization of the optical switches, as well as from modifications in the optical properties of the pump and/or probe beams or pulses described herein. Thus, the examples presented in these figures, encompassing a range of material compositions, structural configurations, and light manipulation strategies, are intended to provide a better understanding of potential capabilities and functionalities of the optical switches and pump/probe interactions by elucidating several underlying principles and operational mechanisms that enable the dynamic modulation of light within these optical switches for various applications.

FIG. 2 depicts a probe beam 204 and a pump beam 206 interacting with an example all-optical switch 202, in accordance with various embodiments described herein. As previously mentioned, switchable optical devices enable real-time control over the polarization, amplitude, or phase of light. In all-optical switching, a light pulse (e.g., pump beam 206) interacts with the all-optical switch's 202 constituent material, changing its optical response to ultimately adjust the incident probe beam 204 to create an adjusted/output probe beam 208. For example, the pump beam 206 (e.g., an intraband pump) can energize free electrons in a transparent conducting oxide (TCO), increasing their effective mass, making the materials less absorptive and thus increasing the switch's 202 overall transmission. Conversely, the pump beam 206 can generate photocarriers that increase the switch's 202 metallicity and absorption. Still further, the all-optical switch 202 may generally adjust the incident probe beam 204 by modulating/controlling the incident probe beam's 204 amplitude, phase, polarization, direction, and/or any other suitable characteristics or combinations thereof that result in the adjusted/output probe beam 208 having at least one different characteristic from the incident probe beam 204 as a result of interacting with the all-optical switch 202.

Importantly, the all-optical switch 202 can operate without the resistive-capacitive delays of electronic circuits. Instead, the speed of optically induced permittivity modulation is limited by the relaxation mechanisms of the switching material (e.g., material layers 202a-m), which can range from a few femtoseconds to several nanoseconds. Such fast permittivity changes within the all-optical switch 202 enables several interesting phenomena and applications that are not achievable by other means of switching, such as nonreciprocal optical devices, photon acceleration, and ultrafast optical switching.

The wavelength range where the real part of the dielectric permittivity for any individual material layer 202a-202n changes its sign is known as the Epsilon-Near-Zero (ENZ) regime. Strong light-matter interaction due to the large field enhancement and the slow group velocity of light near the ENZ point enables a plethora of optical phenomena without the need for complex composite structures. For example, the optical phenomena include dramatic reflectance and transmittance modulation, strong nonlinearity enhancement, time refraction, broadband and narrowband absorption, optical time reversal, high-harmonic generation, and/or on-chip modulators.

In any event, the all-optical switch 202 relies on two major functionalities: the magnitude of the dielectric permittivity change, which governs the modulation depth, and the overall material response time that governs the switching speed. However, controlling the speed of the all-optical switch 202 is necessarily limited because the relaxation time of the material layers 202a-n is an intrinsic property. The relaxation time can be changed or adjusted at the film growth/fabrication step but not dynamically during the all-optical switch's 202 operation. Thus, the overall switching response is generally fixed after fabrication.

To mitigate the effects of relaxation time, the all-optical switch 202 of FIG. 2 may include multiple materials as part of the material layers 202a-n that have significantly different relaxation times. For example, the first material layer 202a may be AZO, and the second material layer 202b may be plasmonic TiN. Individual transient characterization of TiN demonstrates an overall relaxation time spanning nanoseconds, while that of AZO shows a much faster relaxation time spanning picoseconds. The remaining material layers 202n, 202m may include other suitable materials, identical materials to the other layers 202a, 202b, and/or may include a substrate (e.g., material layer 202m) to which the other material layers 202a-n are affixed.

It should be appreciated that the all-optical switch 202 may be comprised of any suitable number of material layers 202a-m, such that n and m may be any suitable integer values. Further, it should be appreciated that the responses and characteristics of the material layers within the all-optical switch 202 can also be tailored through precise control of the material concentrations and doping schemes. Specifically, the functionality and performance of the all-optical switch 202 can be influenced by deliberately including or excluding certain materials in each layer to achieve the desired optical responses. For instance, by doping a transparent TCO layer with specific elements, the effective mass of free electrons can be modified to alter the materials' absorptive properties, resulting in enhanced transmission characteristics. Moreover, the relaxation time of each material layer can be adjusted by selective doping or concentration control during the fabrication process, impacting the overall switching speed of the device. The inclusion of multiple materials with varying relaxation times within the material layers 202a-n may allow for the optimization of switching speed and modulation depth.

Thus, in this example, the all-optical switch 202 is at least a double-resonant device that supports a radiative ENZ mode in the TiN layer and a Ferrell Berreman mode in the AZO layer. When the pump beam 206 interacts with the all-optical switch 202, electrons in both TiN and AZO are simultaneously excited, leading to transient reflectance modulation due to changes in permittivity. Notably, the reflectance modulation is most pronounced near the ENZ regions of the corresponding material layers 202a-n. As a result, the all-optical switch 202 has switching times of nanosecond-speed in proximity to the ENZ wavelength of TiN, following its carrier dynamics, and picoseconds, close to the ENZ of AZO, consistent with AZO dynamics.

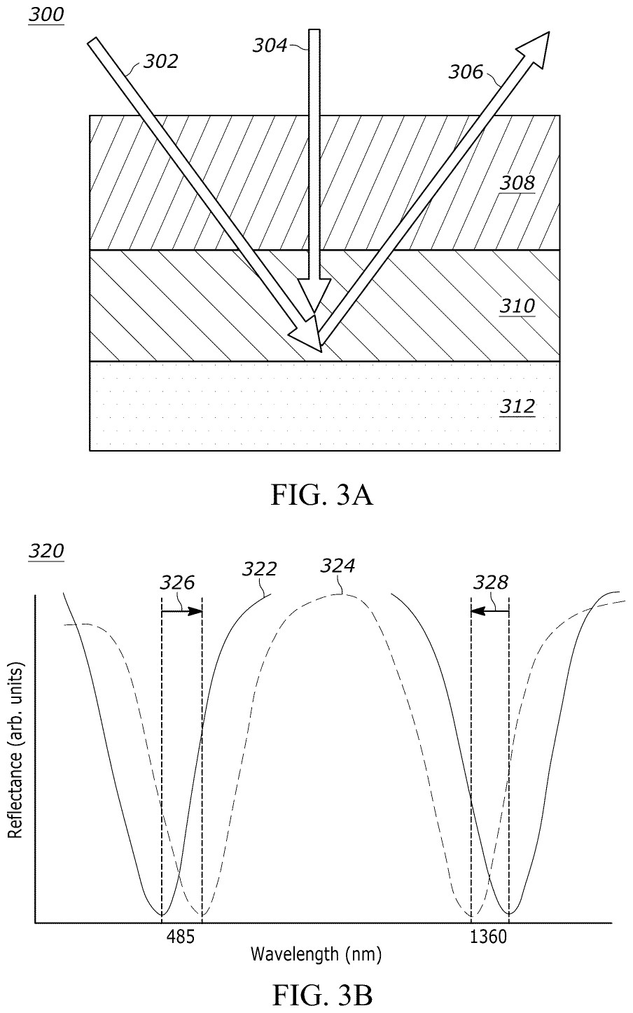

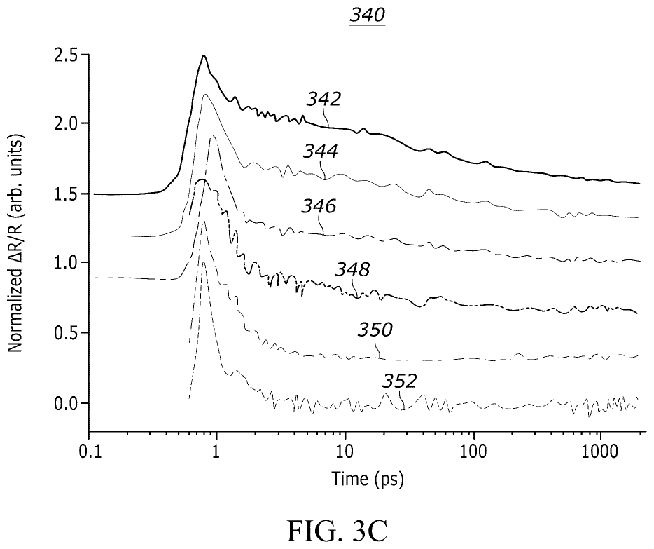

However, the all-optical switch's 202 switching time can be further controlled by utilizing/varying a multitude of optical parameters/characteristics, including the angle of incidence, the wavelength, and the polarization of the pump beam 206 and/or the probe beam 204. To better understand these effects stemming from the pump beam 206 and the probe beam 204, FIG. 3A depicts an example double-resonant two-layer optical switch device 300, in accordance with various embodiments described herein. More specifically, an incident probe beam/pulse 302 and a pump beam/pulse 304 transmit through a first material layer 308 and a second material layer 310, and these material layers 308, 310 adjust a property of the incident probe beam/pulse 302 to result in the output probe beam/pulse 306. The optical switch device 300 further includes a substrate layer 312.

In certain embodiments, the optical switch device 300 is a TiN-AZO Ferrell-Berreman (FB) resonator, where the second layer 310 is a 130-nm-thick layer of TiN on the substrate layer 312, which may be silicon. The optical switch device 300 further includes a first layer 308 comprising a 250-nm-thick AZO layer. Based on these materials as the respective layers 308, 310, the optical switch device 300 possesses tunable switching response times when operated in tandem with the tunable optical characteristics of the pump beam/pulse 304 and/or the probe beam/pulse 302.

As an example, the pump beam/pulse 304 may be a normal-incidence 325-nm-wavelength beam, which is absorbed in the first layer 308 (AZO) and the second layer 310 (TIN). At normal incidence, the 325-nm wavelength pump beam/pulse 304 may be strongly absorbed in the first layer 308 and the second layer 310 by exciting electrons in both materials. As mentioned, the materials interact most strongly with light near their respective ENZ wavelengths. Thus, when the probe beam/pulse 302 encounters the material layers 308, 310 at visible wavelengths, the probe beam/pulse 302 may primarily interact with the second layer 310. However, if the probe source is adjusted to output a probe beam/pulse 302 in near-infrared (IR) wavelengths, the probe beam/pulse 302 may interact strongly with the first layer 308. In the example of FIG. 3A, the probe beam/pulse 302 has an angle of incidence of approximately 50°, but as discussed herein, the probe beam/pulse 302 and/or the pump beam/pulse 304 may have any suitable angle of incidence to illicit the desired optical response from the optical switch device 300.

FIG. 3B depicts an example reflectance spectrum shifting resulting from pump interactions with an optical switch device, in accordance with various embodiments described herein. More specifically, the reflectance spectrum shifting plot 320 indicates the reflectance of an optical switch device at various wavelengths based on the device being pumped (reflectance curve 322) or unpumped (reflectance curve 324).

In the example illustrated by FIG. 3B, the optical switch may have a first layer of AZO and a second layer of TiN. In this example, the reflectance spectrum shifting plot 320 shows two reflectance dips for p-polarized light (e.g., of a probe beam) near the ENZ points of TiN and AZO. The TiN layer may have an ENZ point in the visible spectrum, such that the reflectance curves 322, 324 feature a significant dip in the visible wavelengths (e.g., approximately 485 nm). The AZO layer may have an ENZ point in near-IR wavelengths, such that the reflectance curves 322, 324 feature another significant dip in the near-IR wavelengths (e.g., approximately 1360 nm). As illustrated in FIG. 3B, the pump beam generally causes the reflectance curve 322 to redshift (e.g., illustrated by shift 326) to the reflectance curve 324 at visible wavelengths, whereas, at near-IR wavelengths, the pump beam generally causes the reflectance curve 322 to blueshift (e.g., illustrated by shift 328) to the reflectance curve 324.

FIG. 3C depicts example response time variations for a multi-layered optical switch device in response to interactions with a probe at different wavelengths, in accordance with various embodiments described herein. The response time variation plot 340 of FIG. 3C generally illustrates the reflectance modulation versus pump-probe delay time. This modulation for each wavelength indicated by the plot 340 may be normalized to a maximum response at each wavelength and may also be shifted to the same time, for ease of discussion. Further, starting from the sixth response time curve 352, the datasets for each wavelength are vertically shifted by 0.3 from each adjacent curve for easier viewing. Generally, as the probe wavelength increases, the relaxation rate transitions gradually from nanosecond to picosecond-scales.

Specifically, the response time variation plot 340 of FIG. 3C includes a response time curve 342, 344, 346, 348, 350, 352 for each of a variety of probe wavelengths. For example, the first response time curve 342 may represent the response time of an optical switch in response to interacting with a probe beam at approximately 508 nm, the second response time curve 344 may represent the response time of the optical switch in response to interacting with a probe beam at approximately 600 nm, the third response time curve 346 may represent the response time of the optical switch in response to interacting with a probe beam at approximately 750 nm, the fourth response time curve 348 may represent the response time of the optical switch in response to interacting with a probe beam at approximately 900 nm, the fifth response time curve 350 may represent the response time of the optical switch in response to interacting with a probe beam at approximately 1180 nm, and the sixth response time curve 352 may represent the response time of the optical switch in response to interacting with a probe beam at approximately 1300 nm.

In certain embodiments, the response time variation plot 340 may indicate the response times of a multi-resonance/material optical switch that includes at least a TiN layer and an AZO layer, as described herein. Generally, TiN has a nanosecond response time and AZO has a picosecond response time. Thus, when excited by the same pump, the optical switch device has a slower observed response time in the visible probe wavelengths, where its behavior is dominated by the TiN response. At increasing wavelengths (e.g., progressing from first response time curve 342 to sixth response time curve 352), its response accelerates as the relative light-matter interaction of the probe with the AZO increases.

In particular, the reflectance modulation occurs at nanosecond timescales for visible wavelengths and accelerates as the wavelength increases, until it reaches picosecond timescales at NIR wavelengths. This transition occurs because, in the visible spectrum, the probe light is mostly localized in and interacts strongly with TiN. The slow carrier dynamics of TiN therefore dominate the dynamics of the optical switch. Similarly, near the ENZ point of AZO at NIR wavelengths, AZO carrier dynamics drive the switching speed. The switching speed between the two material resonances is generally between the TiN and AZO relaxation times, and the speed increases as the probe wavelength approaches the AZO resonance. Thus, by exploiting the material nonlinearities, the optical devices described herein can operate at speeds ranging from the GHz to the THz regime, differing by two orders of magnitude with the same optical pump.

More generally, the effective temporal response of the optical switch device, as illustrated in FIG. 3C, can be modeled as a weighted sum of the individual responses of the materials:

$$( \frac{Δ R}{R} ) ( t ) = ∝ ( {Ae}^{\frac{- t}{τ 1}} + {Be}^{\frac{- t}{τ2}} ) + β {De}^{\frac{- t}{τ}} + Γ , \qquad ( 1 )$$

where α is the weighted contribution of TiN (with the 2-time constants τ1 & τ2) and β is the weighted contribution of the AZO (single time constant τ). Γ is an offset attributed to slower thermal effects and noise due to probe fluctuations.

As the probe wavelength increases, more light interacts with the AZO versus TiN. Thus, AZO dictates the modulation dynamics, resulting in faster response dynamics. It is therefore possible to control the switching speed of the same optical switch device from nanosecond to picosecond scales by simply changing the wavelength of operation. However, the relaxation response can be further controlled by incorporating/manipulating various parameters associated with the pump beam. For example, wavelength-dependent relaxation dynamics of the individual materials, the magnitude of reflectance modulation in the individual materials, resonance shifts, ultrafast non-equilibrium dynamics of hot-electrons in the materials and interfaces, the effect of surface roughness on carrier recombination, and/or other nonlinearities triggered by the strong pump beam can further influence the relaxation/response times, as discussed herein.

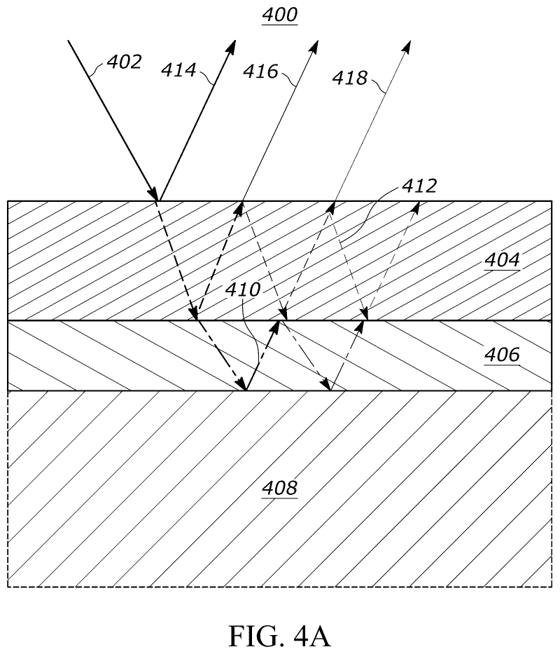

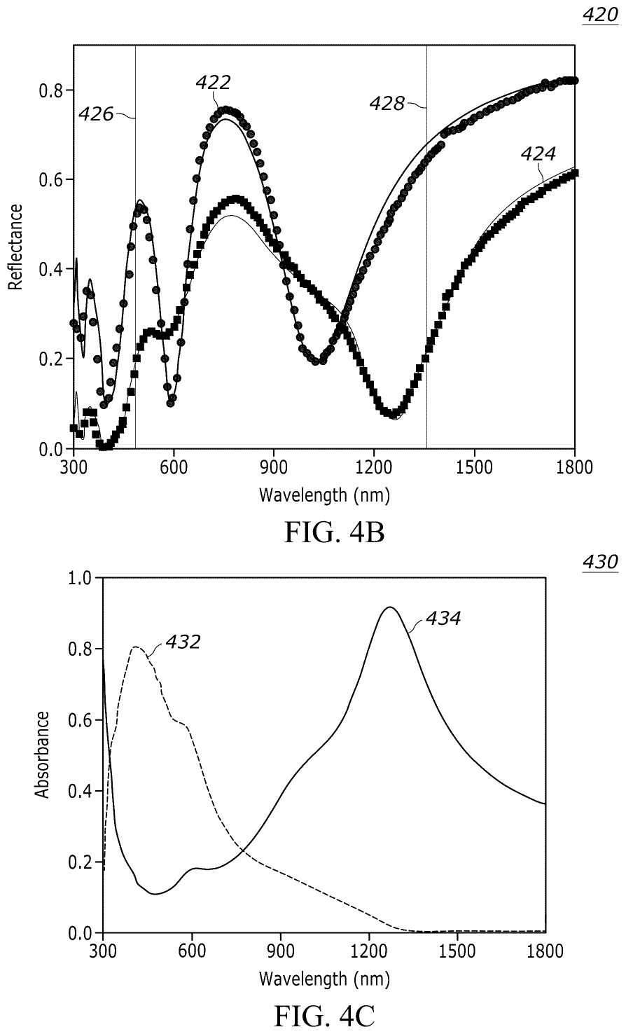

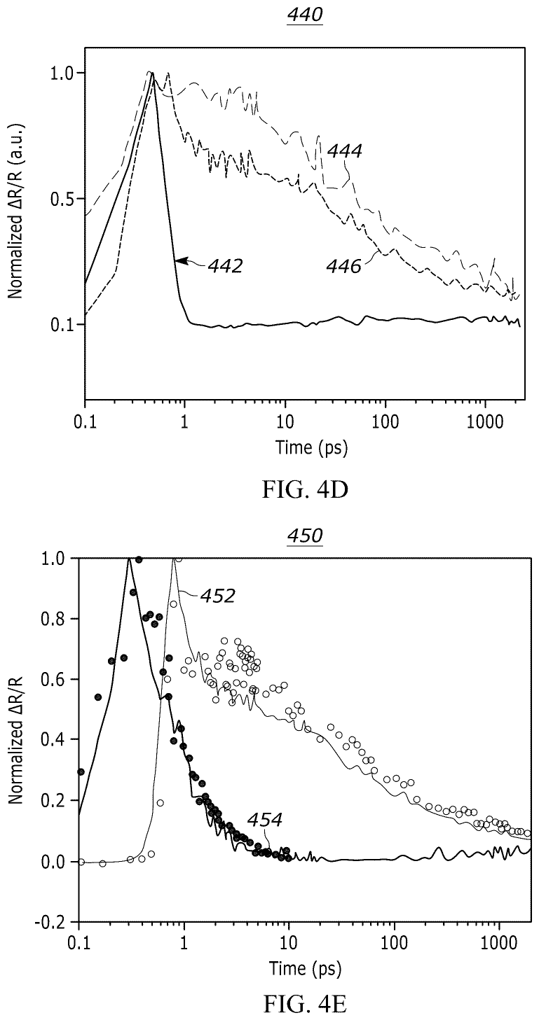

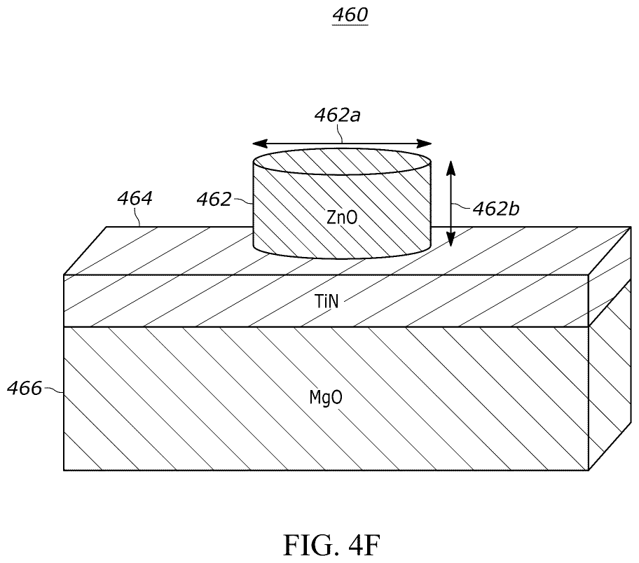

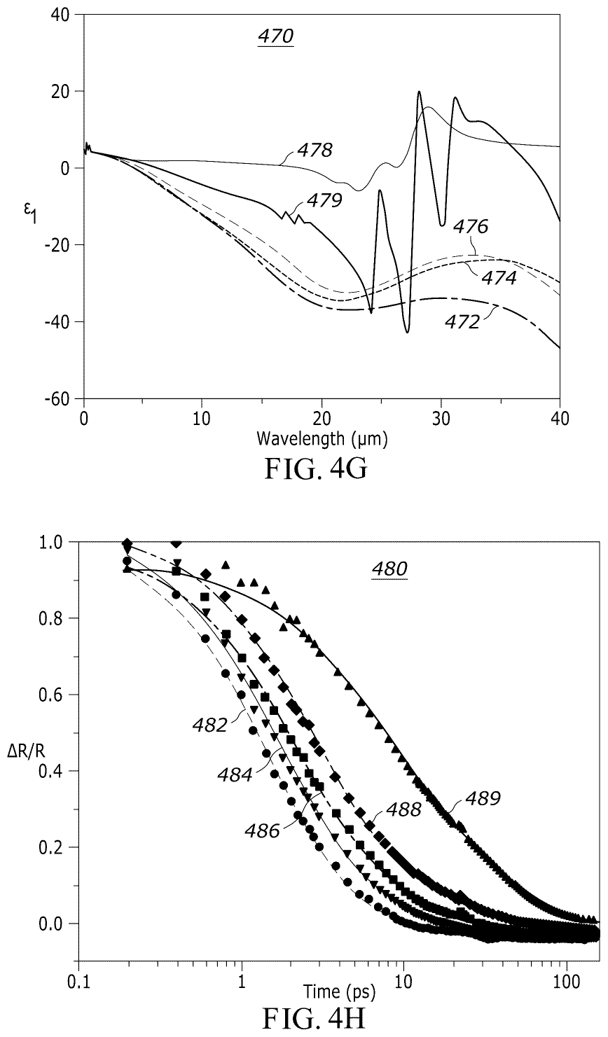

FIG. 4A depicts an example two-layer TiN-AZO optical switch device 400 receiving an incident probe beam 402, in accordance with various embodiments described herein. Generally, the TiN-AZO optical switch device 400 is configured to directly couple free-space p-polarized light from the probe beam 402 and comprises a first layer 404, a second layer 406, and a reflective layer 408. As illustrated in FIG. 4A, the optical switch device 400 receives the incident probe beam 402, which is partially reflected at the first layer 404 (e.g., AZO layer), the second layer 406 (e.g., TiN layer), and the reflective layer 408 (e.g., Si substrate) and emitted from the optical switch device 400 in the form of s-polarized light 414, 416, 418. Thus, the light beams 410, 412 that are coupled within the first layer 404 and the second layer 406 represent p-polarized light.

Consequently, the optical switch device 400 has response characteristics that are also polarization dependent. To illustrate these response characteristics, FIG. 4B is an example reflectance plot 420 depicting example reflectance spectra 422, 424 for s-polarized and p-polarized light interacting with an all-optical switch device, in accordance with various embodiments described herein. For example, the reflectance spectra 422, 424 depicted in FIG. 4B may represent the reflectance of s-polarized and p-polarized light with an incidence angle of approximately 50° when interacting with the optical switch device 400 of FIG. 4A.

As illustrated in the example reflectance plot 420, near the ENZ wavelengths 426, 428 of the respective layers, p-polarized light (represented by reflectance spectra 424) generally couples into either a radiative ENZ or an FB mode. By contrast, s-polarized light (represented by reflectance spectra 422) is generally coupled into Fabry-Perot modes or is reflected. Near the AZO ENZ wavelength 428 (e.g., approximately 1360 nm), p-polarized light couples into a radiative Berreman mode, resulting in a reflectance dip. TiN is metallic near the AZO ENZ wavelength 428, and therefore serves as a back reflector required for the Berreman mode.

On the other hand, near the TIN ENZ wavelength 426, AZO is a dielectric allowing light to pass into the TiN layer (e.g., second layer 406). Silicon's high refractive index allows it to act as a reflective backreflector, allowing light to couple into the radiative ENZ mode in the TiN layer, and resulting in the reflectance dip near the TIN ENZ wavelength 426 (e.g., approximately 485 nm). Thus, the optical switch device 400 (and others described herein) supports a radiative ENZ mode in the visible spectrum/wavelengths and a Ferrell-Berreman mode in the infrared spectrum/wavelengths, further highlighting the tunable capabilities of the systems and methods described herein.

FIG. 4C depicts example absorption spectra plot 430 for p-polarized light interacting with an all-optical switch device, in accordance with various embodiments described herein. The absorbance of the p-polarized light in the optical switch device depicted by the example absorption spectra plot 430 highlights that the probe/pump light interacts strongly with individual films near their respective ENZ points.

For example, a pump beam/pulse under normal incidence at 325 nm experiences 48% absorption in the TiN layer (represented by absorption curve 432) and 39% in the AZO layer (represented by absorption curve 434). Thus, upon excitation by the pump, electrons in both the AZO layer and the TiN layer are excited, modulating the permittivity of both materials. Carriers in the AZO layer relax at ultrafast timescales (e.g., femto/picoseconds) while the permittivity of the TiN layer takes longer to achieve steady-state (e.g., nanoseconds) due to its slower lattice cooling relaxation process.

Similarly, approximately 80% of p-polarized light is absorbed in the TiN layer near its ENZ point in the visible spectrum (e.g., near the peak of absorption curve 432). Further, approximately 90% of p-polarized is absorbed by the AZO layer near its ENZ point in the NIR spectrum (e.g., near the peak of absorption curve 434). Thus, visible wavelength probes interact strongly with the TiN layer near its ENZ, resulting in slower, nanosecond switching times. On the other hand, NIR probes with wavelengths near the AZO layer ENZ interact strongly with the AZO layer, resulting in ultrafast, femto/picosecond scale switching times.

FIG. 4D depicts the femtosecond response time of an all-optical switch device based on pump wavelength, in accordance with various embodiments described herein. FIG. 4D is a response time plot 440 that includes a first response time curve 442, a second response time curve 444, and a third response time curve 446.

The first response time curve 442 generally corresponds to the response time characteristics of an all-optical switch (e.g., comprising AZO, TiN layers) in response to receiving a pump beam/pulse having a wavelength near the ENZ of an ultrafast switching material layer of the all-optical switch. For example, the optical switch may comprise an AZO layer with an ENZ wavelength of approximately 1380-1400 nm. In this example, the first response time curve 442 depicts the response time of the optical switch when a pump beam/pulse having a wavelength of approximately 1380-1400 nm interacts with the optical switch. As illustrated in FIG. 4D, the response time of the optical switch is on the order of 1 picosecond or less (e.g., femtoseconds).

By contrast, the second response curve 444 illustrates the response time of a different material layer within the optical switch device that does not have an ENZ wavelength corresponding to the wavelength of the pump beam/pulse. Continuing the prior example, the optical switch may further comprise a TiN layer with an ENZ wavelength of approximately 485-500 nm. In this example, the second response time curve 444 depicts the response time of the TiN layer when the pump beam/pulse having a wavelength of approximately 1380-1400 nm interacts with the optical switch. As illustrated in FIG. 4D, the response time of the individual TiN layer is on the order of nanoseconds, which is significantly slower than the overall optical switch device response time resulting from the AZO layer (e.g., first response curve 442).

The third response curve 446 illustrates the response time of the optical switch device when the pump beam/pulse wavelength is different from the ENZ wavelength of any ultrafast (e.g., femto/picosecond) response materials. Continuing the prior example, the third response curve 446 may illustrate the response time resulting from the optical switch device's interaction with a pump having a wavelength of approximately 325 nm. As illustrated in FIG. 4D, the response time of the optical switch device is clearly slower when the pump beam/pulse has a wavelength that is significantly different than the ENZ wavelength of any ultrafast response materials (e.g., AZO layer) and is substantially closer to the response times achieved by the pump strongly interacting with slower response materials (e.g., TiN layer). In particular, the response time of the optical switch is on the order of nanoseconds.

To further illustrate the phenomenon of pump/probe wavelength dependent response times, FIG. 4E overlaps the temporal response of an optical switch device with the temporal responses of the individual thick films at different wavelengths. Specifically, FIG. 4E depicts an example transient modulation response of an all-optical switch device in relation to probe wavelength, in accordance with various embodiments described herein.

FIG. 4E includes a modulation response time plot 450 with a first modulation response time curve 452 and a second modulation response time curve 454. The first modulation response time curve 452 represents the response time of the optical switch device at a probe wavelength of approximately 508 nm and the second modulation response time curve 454 represents the response time of the optical switch device at a probe wavelength of approximately 1180 nm. The individual points proximate to the respective curves 452, 454 may represent the modulation responses of individual films/material layers, such as a TiN film/layer at approximately 505 nm (e.g., proximate to the first modulation response time curve 452) and an AZO film/layer at approximately 1210 nm (e.g., proximate to the second modulation response time curve 454). It should be noted that the slower TiN dynamics in relation to the first modulation response time curve 452 are shifted by 0.4 picoseconds for the purposes of clarity.

As illustrated in the first modulation response time curve 452 (e.g., at 508 nm), the modulation dynamics of the multi-layer optical switch device closely follow that of the TIN film/layer on a silicon substrate (e.g., represented by the dots proximate to the curve 452), as the probe strongly interacts with the TiN layer. By contrast, in the second modulation response time curve 454 (e.g., at 1180 nm), the probe strongly interacts with the AZO film/layer, as shown by the strong absorbance of p-polarized light in the AZO. As a result, the modulation speed at 1180 nm nearly mirrors that of the AZO film/layer on a silicon substrate (e.g., represented by the dots proximate to the curve 454).

FIG. 4F depicts an example multi-material all-optical switch device 460 comprising individual layers of different shapes/dimensions, in accordance with various embodiments described herein. The example multi-material all-optical switch device 460 is generally a nanopatterned device that is configured to switch/operate in response to various wavelengths of pump/probe light and at various different speeds. In particular, these operating characteristics are influenced by the physical dimensions/shape of the individual layers.

As illustrated in FIG. 4F, the multi-material all-optical switch device 460 includes a first layer 462 of Zinc oxide (ZnO), a second layer 464 of TiN, and a third layer 466 of Magnesium oxide (MgO). The first layer 462 has different dimensions than the second layer 464 and the third layer 466, and these dimensions are represented by the first layer width 462a and the first layer height 462b. Further, the first layer 462 is generally shaped differently than the second layer 464 or the third layer 466, such that the first layer 462 is cylindrical, whereas the second layer 464 and the third layer 466 are rectangular. Taken together, these dimensional and shape differences yield further nuances to the optical characteristics of the all-optical switch device 460. Accordingly, adjusting the first layer width 462a, the first layer height 462b, and/or the shape of the first layer 462 may result in different operating characteristics of the all-optical switch device 460, which can therefore be tuned to suit any particular use case(s).

Thus, it should be appreciated that the optical switches described herein may be comprised of any suitable material(s) in any suitable layering, dimension, and/or shape. For example, any of the optical switches described herein may include TIN, AZO, ZnO, MgO, Gold (Au), Silver (Ag), Cadmium oxide (CdO), Gallium-doped zinc oxide (GZO), Indium tin oxide (ITO), Zirconium nitride (ZrN), and/or any other suitable materials or combinations thereof. Each of these various materials may provide specific response times that are desirable in a particular use-case, such as femtoseconds (e.g., Au, CdO), picoseconds (e.g., CdO, AZO, GZO, ITO), and/or nanoseconds (e.g., TiN, ZrN).

FIG. 4G depicts example permittivity response curves of an optical switch device in relation to probe wavelength, in accordance with various embodiments described herein. The permittivity variation plot 470 of FIG. 4G generally illustrates the permittivity variation versus pump/probe wavelength for a variety of different oxides that may comprise the optical switch, and as illustrated by the plot 470, the various oxides may produce ENZ wavelengths generally spanning from approximately 4 μm (e.g., the first permittivity response curve 472) to approximately 25 μm (e.g., the fourth permittivity response curve 478).

Specifically, the permittivity variation plot 470 of FIG. 4G includes a permittivity response curve 472, 474, 476, 478, and 479 for each of a variety of oxides that may comprise at least a portion of an optical switch. For example, the first permittivity response curve 472 may represent the permittivity responses of at least a portion (e.g., a single layer) of an optical switch comprising ITO as a function of wavelength (e.g., in μm), the second permittivity response curve 474 may represent the permittivity responses of at least a portion of an optical switch comprising an amorphous form of Indium Zinc Tin Oxide (IZTO), the third permittivity response curve 486 may represent the permittivity responses of at least a portion of an optical switch comprising Indium Zinc Oxide (IZO), the fourth permittivity response curve 488 may represent the permittivity responses of at least a portion of an optical switch comprising a crystalline form of IZTO, and the fifth permittivity response curve 489 may represent the permittivity responses of at least a portion of an optical switch comprising Indium (III) Oxide (In₂O₃).

As illustrated in the permittivity variation plot 470, the materials associated with the fourth permittivity response curve 488 and the fifth permittivity response curve 489 exhibit multiple crossings of the ENZ threshold across a variety of pump/probe wavelengths, extending potentially up to 36 microns. The multiple ENZ wavelengths observed with these materials may imply that they possess versatile capabilities for manipulating light within a broad spectral range, enabling control over different aspects of the optical signal such as phase, amplitude, and/or polarization at various wavelengths. For example, the fourth permittivity response curve 488 may include ENZ values at approximately 18 microns, 25 microns, and 27 microns, and the fifth permittivity response curve 489 may include ENZ values at approximately 6 microns, 28 microns, 30 microns, 32 microns, and 36 microns.

FIG. 4H depicts example recombination time variations for optical switch devices comprised of various materials, in accordance with various embodiments described herein. The recombination time variation plot 480 of FIG. 4H generally illustrates the reflectance modulation versus time for a variety of different oxides that may comprise the optical switch, and as illustrated by the plot 480, the various oxides may produce recombination times generally spanning from approximately 10 ps (e.g., the first recombination time curve 482) to approximately 100 ps (e.g., the fifth recombination time curve 489).

Specifically, the recombination time variation plot 480 of FIG. 4H includes a recombination time curve 482, 484, 486, 488, and 489 for each of a variety of oxides that may comprise at least a portion of an optical switch. For example, the first recombination time curve 482 may represent the recombination time of at least a portion (e.g., a single layer) of an optical switch comprising ITO, the second recombination time curve 484 may represent the recombination time of at least a portion of an optical switch comprising an amorphous form of IZTO, the third recombination time curve 486 may represent the recombination time of at least a portion of an optical switch comprising IZO, the fourth recombination time curve 488 may represent the recombination time of at least a portion of an optical switch comprising a crystalline form of IZTO, and the fifth recombination time curve 489 may represent the recombination time of at least a portion of an optical switch comprising In₂O₃.

As previously mentioned, optical switches comprised at least partially of a TiN layer and an AZO layer (e.g., the multi-material all-optical switch device 460) may have similar recombination times as those illustrated in the plot 480 at pump/probe wavelengths between approximately 480 nm to approximately 1400 nm. However, optical switches that include layers comprised of one or more of the oxides represented by the plot 480 may have similar recombination times (e.g., 10-100 ps) as the TiN/AZO switches at pump/probe wavelengths of approximately 4 microns to approximately 25 microns. Thus, an optical switch device comprising one or more of these oxides represented in the plot 480 may have a similarly fast observed response time as the TiN/AZO switches described herein at infrared probe wavelengths. For example, an optical switch may comprise a layer of crystalline IZTO and a layer of TiN to achieve ENZ crossovers at approximately 480 nm (e.g., the TiN layer) up to approximately 25 μm (e.g., the crystalline IZTO layer).

More specifically, the recombination time variation plot 480 may indicate the recombination times of at least part (e.g., a single layer) of a multi-material optical switch that may include a TiN layer, an AZO layer, and/or one or more of the oxides represented by the curves 482-489 of the plot 480. For example, a first optical switch may comprise a first layer of In₂O₃ and a second layer of AZO and a second optical switch may comprise a first layer of TiN and a second layer of ITO. The first optical switch may have operating characteristics comprising ENZ values of approximately 1400 nm (e.g., the AZO layer) and approximately 8 μm (e.g., the In₂O₃ layer) and switching speeds of approximately 10 ps (e.g., the AZO layer) and 100 ps (e.g., the In₂O₃ layer). The second optical switch may have operating characteristics comprising ENZ values of approximately 480 nm (e.g., the TiN layer) and approximately 4 μm (e.g., the ITO layer) and switching speeds of approximately 10 ps (e.g., the ITO layer) and 100 ps (e.g., the TiN layer). Accordingly, the oxides represented by the recombination time variation plot 480 and the permittivity variation plot 470 of FIG. 4G may be combined with one or more of the other materials described herein (e.g., AZO, TiN) to create mixed-material optical switches with desirable response characteristics.

Further, the use of materials represented in the various plots (e.g., 470, 480) described herein, particularly IZTO, IZO, and/or In₂O₃, can significantly enhance the performance of optical switch devices in the context of signal transmission in atmospheric configurations like satellite communications. These materials exhibit unique permittivity responses and recombination times that make them suitable for transmitting signals at specific wavelengths (e.g., ranging from approximately 4 μm to 35 μm) that align well with the atmospheric window for satellite communication. In this spectral range (e.g., specific wavelengths in the mid-infrared region), the atmospheric effects such as absorption, scattering, and/or other propagation impairments may be minimized. This spectral region, also known as the “atmospheric window”, experiences lower levels of absorption by atmospheric gases like water vapor and carbon dioxide compared to other parts of the electromagnetic spectrum. As a result, signals within this range encounter less attenuation and interference from atmospheric components, enabling more efficient transmission through the atmosphere. Moreover, signals at these specific wavelengths can propagate over long distances with minimal distortion and signal degradation, making them well-suited for satellite communication applications where maintaining signal integrity and reliability are important.

Thus, by incorporating these materials (e.g., in plots 470, 480) into the optical switch devices, they may achieve fast response times and efficient modulation of signals within the infrared spectrum relevant for communication in the Earth's atmosphere. For example, a configuration combining IZTO with TiN layers can enable ENZ crossovers that match the wavelengths needed for effective signal transmission through the atmosphere. Moreover, combining these oxides with other materials like AZO and TiN can create mixed-material optical switches with tailored response characteristics to optimize signal transmission efficiency in atmospheric conditions, making them well-suited for satellite communication applications.

### Example Computer-Implemented Methods

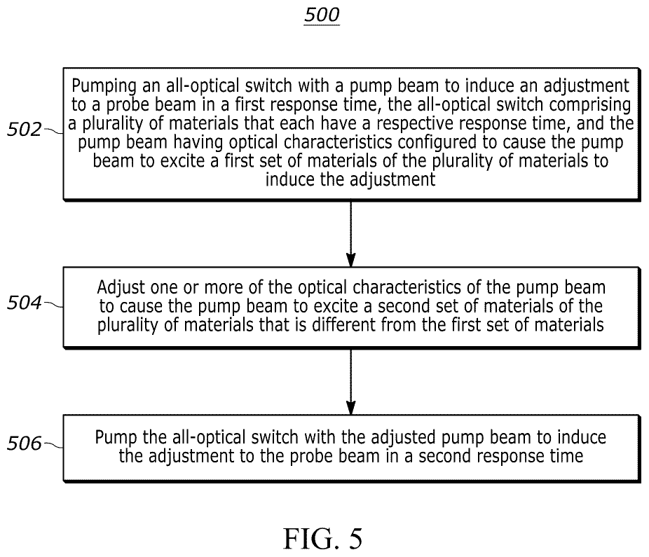

FIG. 5 depicts a first flow diagram representing an example computer-implemented method 00, in accordance with various embodiments described herein. The method 500 may be implemented by one or more processors of the example computing system 100, such as the processor 104a of computing device 104 and/or the optical system 102, for example.

The method 500 includes pumping an all-optical switch with a pump beam to induce an adjustment to a probe beam in a first response time (block 502). The all-optical switch may comprise a plurality of materials that each have a respective response time, and the pump beam may have optical characteristics configured to cause the pump beam to excite a first set of materials of the plurality of materials to induce the adjustment. The method 500 further includes adjusting one or more of the optical characteristics of the pump beam to cause the pump beam to excite a second set of materials of the plurality of materials that is different from the first set of materials (block 504). The method 500 further includes pumping the all-optical switch with the adjusted pump beam to induce the adjustment to the probe beam in a second response time (block 506).

In certain embodiments, adjusting the one or more of the optical characteristics of the pump beam further includes adjusting one or more of: (i) a wavelength of the pump beam, (ii) an incidence angle of the pump beam, or (iii) a polarization of the pump beam. In these embodiments, the wavelength of the pump beam ranges from approximately 325 nm to approximately 1400 nm.

In some embodiments, each material of the plurality of materials has a respective resonant frequency, and adjusting the one or more of the optical characteristics of the pump beam further includes adjusting a wavelength of the pump beam to the respective resonant frequency of the second set of materials.

In certain embodiments, the first response time is approximately 10 nanoseconds, and the second response time is approximately 500 femtoseconds.

In some embodiments, the plurality of materials comprises a layer of AZO having a thickness of approximately 250 nm and a layer of TiN having a thickness of approximately 130 nm.

In certain embodiments, the plurality of materials includes three or more materials.

In some embodiments, the method 500 further includes adjusting one or more optical characteristics of the probe beam to cause the probe beam to excite the second set of materials.

In certain embodiments, adjusting the one or more optical characteristics of the probe beam further includes adjusting one or more of: (i) a wavelength of the probe beam, (ii) an incidence angle of the probe beam, or (iii) a polarization of the probe beam.

In some embodiments, the plurality of materials comprises at least a first layer and a second layer, and wherein the first layer or the second layer is comprised of one or more of: (i) AZO, (ii) TiN, (iii) ITO, (iv) IZO, (v) an amorphous form of IZTO, (vi) a crystalline form of IZTO, (vii) In₂O₃, and/or (viii) other materials with an epsilon-near-zero crossover or other resonances in the desired range.

In certain embodiments, the all-optical switch at least partially comprises an optical system that is configured to at least partially perform at least one of: (i) signal routing, (ii) signal processing, and/or (iii) logic operations within a communications system.

In some embodiments, the wavelength of the pump beam and/or the probe beam ranges from approximately 325 nm to approximately 35 μm.

Of course, it is to be appreciated that the actions of the method 500 may be performed any suitable number of times, and that the actions described in reference to the method 500 may be performed in any suitable order.

### Aspects

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above but are instead meant to be exemplary in nature.

Aspect 1. A method for controlling response times of an all-optical switch comprising: pumping an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment; adjusting one or more of the optical characteristics of the pump beam to cause the pump beam to excite a second set of materials of the plurality of materials that is different from the first set of materials; and pumping the all-optical switch with the adjusted pump beam to induce the adjustment to the probe beam in a second response time.

Aspect 2. The method of aspect 1, wherein adjusting the one or more of the optical characteristics of the pump beam further comprises: adjusting one or more of: (i) a wavelength of the pump beam, (ii) an incidence angle of the pump beam, or (iii) a polarization of the pump beam.

Aspect 3. The method of aspect 2, wherein the wavelength of the pump beam ranges from approximately 325 nanometers (nm) to approximately 1400 nm.

Aspect 4. The method of any of aspects 1 through 3, wherein each material of the plurality of materials has a respective resonant frequency, and wherein adjusting the one or more of the optical characteristics of the pump beam further comprises: adjusting a wavelength of the pump beam to the respective resonant frequency of the second set of materials.

Aspect 5. The method of any of aspects 1 through 4, wherein the first response time is approximately 10 nanoseconds and the second response time is approximately 500 femtoseconds.

Aspect 6. The method of any of aspects 1 through 5, wherein the plurality of materials comprises a layer of Aluminum-doped Zinc Oxide (AZO) having a thickness of approximately 250 nm and a layer of Titanium Nitride (TiN) having a thickness of approximately 130 nm.

Aspect 7. The method of any of aspects 1 through 6, wherein the plurality of materials includes three or more materials.

Aspect 8. The method of any of aspects 1 through 7, further comprising: adjusting one or more optical characteristics of the probe beam to cause the probe beam to excite the second set of materials.

Aspect 9. The method of aspect 8, wherein adjusting the one or more optical characteristics of the probe beam further comprises: adjusting one or more of: (i) a wavelength of the probe beam, (ii) an incidence angle of the probe beam, or (iii) a polarization of the probe beam.

Aspect 10. The method of any of aspects 1 through 9, wherein the plurality of materials comprises at least a first layer and a second layer, and wherein the first layer or the second layer is comprised of one or more of: (i) AZO, (ii) TiN, (iii) Indium Tin Oxide (ITO), (iv) Indium Zinc Oxide (IZO), (v) an amorphous form of Indium Zinc Tin Oxide (IZTO), (vi) a crystalline form of IZTO, or (vii) Indium (III) Oxide (In₂O₃).

Aspect 11. The method of any of aspects 1 through 10, wherein the all-optical switch at least partially comprises an optical system that is configured to at least partially perform at least one of: (i) signal routing, (ii) signal processing, or (iii) logic operations within a communications system.

Aspect 12. The method of any of aspects 1 through 11, wherein the wavelength of the pump beam or the probe beam ranges from approximately 325 nm to approximately 35 μm.

Aspect 13. A computer system for controlling response times of an all-optical switch, the computer system comprising: one or more processors; and a non-transitory computer-readable medium storing thereon instructions that, when executed by the one or more processors, cause the computer system to: pump an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment, adjust one or more of the optical characteristics of the pump beam to cause the pump beam to excite a second set of materials of the plurality of materials that is different from the first set of materials, and pump the all-optical switch with the adjusted pump beam to induce the adjustment to the probe beam in a second response time.

Aspect 14. The computer system of aspect 13, wherein the instructions, when executed by the one or more processors, further cause the computer system to adjust the one or more of the optical characteristics of the pump beam by: adjusting one or more of: (i) a wavelength of the pump beam, (ii) an incidence angle of the pump beam, or (iii) a polarization of the pump beam, wherein the wavelength of the pump beam ranges from approximately 325 nanometers (nm) to approximately 1400 nm.

Aspect 15. The computer system of aspect 13 or 14, wherein each material of the plurality of materials has a respective resonant frequency, and wherein the instructions, when executed by the one or more processors, further cause the computer system to adjust the one or more of the optical characteristics of the pump beam by: adjusting a wavelength of the pump beam to the respective resonant frequency of the second set of materials.

Aspect 16. The computer system of any of aspects 13 through 15, wherein the first response time is approximately 10 nanoseconds and the second response time is approximately 500 femtoseconds.

Aspect 17. The computer system of any of aspects 13 through 16, wherein the plurality of materials comprises a layer of Aluminum-doped Zinc Oxide (AZO) having a thickness of approximately 250 nm and a layer of Titanium nitride (TiN) having a thickness of approximately 130 nm.

Aspect 18. The computer system of any of aspects 13 through 17, wherein the plurality of materials includes three or more materials.

Aspect 19. The computer system of any of aspects 13 through 18, wherein the instructions, when executed by the one or more processors, cause the computer system to: adjust one or more of: (i) a wavelength of the probe beam, (ii) an incidence angle of the probe beam, or (iii) a polarization of the probe beam to cause the probe beam to excite the second set of materials.

Aspect 20. One or more non-transitory computer-readable storage media including instructions that, when executed by one or more processors, cause the one or more processors to: pump an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment; adjust one or more of the optical characteristics of the pump beam to cause the pump beam to excite a second set of materials of the plurality of materials that is different from the first set of materials; and pump the all-optical switch with the adjusted pump beam to induce the adjustment to the probe beam in a second response time.

Aspect 21. The one or more non-transitory computer-readable storage media of aspect 20, wherein the instructions, when executed by the one or more processors, further cause the one or more processors to adjust the one or more of the optical characteristics of the pump beam by: adjusting one or more of: (i) a wavelength of the pump beam, (ii) an incidence angle of the pump beam, or (iii) a polarization of the pump beam, wherein the wavelength of the pump beam ranges from approximately 325 nanometers (nm) to approximately 1400 nm.

ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A method for controlling response times of an all-optical switch comprising:
pumping an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment;
adjusting one or more of the optical characteristics of the pump beam to cause the pump beam to excite a second set of materials of the plurality of materials that is different from the first set of materials; and
pumping the all-optical switch with the adjusted pump beam to induce the adjustment to the probe beam in a second response time.

2. The method of claim 1, wherein adjusting the one or more of the optical characteristics of the pump beam further comprises:
adjusting one or more of: (i) a wavelength of the pump beam, (ii) an incidence angle of the pump beam, or (iii) a polarization of the pump beam.

3. The method of claim 2, wherein the wavelength of the pump beam ranges from approximately 325 nanometers (nm) to approximately 1400 nm.

4. The method of claim 1, wherein each material of the plurality of materials has a respective resonant frequency, and wherein adjusting the one or more of the optical characteristics of the pump beam further comprises:
adjusting a wavelength of the pump beam to the respective resonant frequency of the second set of materials.

5. The method of claim 1, wherein the first response time is approximately 10 nanoseconds and the second response time is approximately 500 femtoseconds.

6. The method of claim 1, wherein the plurality of materials comprises a layer of Aluminum-doped Zinc Oxide (AZO) having a thickness of approximately 250 nm and a layer of Titanium Nitride (TiN) having a thickness of approximately 130 nm.

7. The method of claim 1, wherein the plurality of materials includes three or more materials.

8. The method of claim 1, further comprising:
adjusting one or more optical characteristics of the probe beam to cause the probe beam to excite the second set of materials.

9. The method of claim 8, wherein adjusting the one or more optical characteristics of the probe beam further comprises:
adjusting one or more of: (i) a wavelength of the probe beam, (ii) an incidence angle of the probe beam, or (iii) a polarization of the probe beam.

10. The method of claim 1, wherein the plurality of materials comprises at least a first layer and a second layer, and wherein the first layer or the second layer is comprised of one or more of: (i) AZO, (ii) TiN, (iii) Indium Tin Oxide (ITO), (iv) Indium Zinc Oxide (IZO), (v) an amorphous form of Indium Zinc Tin Oxide (IZTO), (vi) a crystalline form of IZTO, or (vii) Indium (III) Oxide (In₂O₃).

11. The method of claim 1, wherein the all-optical switch at least partially comprises an optical system that is configured to at least partially perform at least one of: (i) signal routing, (ii) signal processing, or (iii) logic operations within a communications system.

12. The method of claim 1, wherein the wavelength of the pump beam or the probe beam ranges from approximately 325 nm to approximately 35 μm.

13. A computer system for controlling response times of an all-optical switch, the computer system comprising:
one or more processors; and
a non-transitory computer-readable medium storing thereon instructions that, when executed by the one or more processors, cause the computer system to:
pump an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment,
adjust one or more of the optical characteristics of the pump beam to cause the pump beam to excite a second set of materials of the plurality of materials that is different from the first set of materials, and
pump the all-optical switch with the adjusted pump beam to induce the adjustment to the probe beam in a second response time.

14. The computer system of claim 13, wherein the instructions, when executed by the one or more processors, further cause the computer system to adjust the one or more of the optical characteristics of the pump beam by:
adjusting one or more of: (i) a wavelength of the pump beam, (ii) an incidence angle of the pump beam, or (iii) a polarization of the pump beam, wherein the wavelength of the pump beam ranges from approximately 325 nanometers (nm) to approximately 1400 nm.

15. The computer system of claim 13, wherein each material of the plurality of materials has a respective resonant frequency, and wherein the instructions, when executed by the one or more processors, further cause the computer system to adjust the one or more of the optical characteristics of the pump beam by:
adjusting a wavelength of the pump beam to the respective resonant frequency of the second set of materials.

16. The computer system of claim 13, wherein the first response time is approximately 10 nanoseconds and the second response time is approximately 500 femtoseconds.

17. The computer system of claim 13, wherein the plurality of materials comprises a layer of Aluminum-doped Zinc Oxide (AZO) having a thickness of approximately 250 nm and a layer of Titanium nitride (TiN) having a thickness of approximately 130 nm.

18. The computer system of claim 13, wherein the plurality of materials includes three or more materials.

19. The computer system of claim 13, wherein the instructions, when executed by the one or more processors, cause the computer system to:
adjust one or more of: (i) a wavelength of the probe beam, (ii) an incidence angle of the probe beam, or (iii) a polarization of the probe beam to cause the probe beam to excite the second set of materials.

20. One or more non-transitory computer-readable storage media including instructions that, when executed by one or more processors, cause the one or more processors to:
pump an all-optical switch with a pump beam to induce an adjustment to a probe beam in a first response time, the all-optical switch comprising a plurality of materials that each have a respective response time, and the pump beam having optical characteristics configured to cause the pump beam to excite a first set of materials of the plurality of materials to induce the adjustment;
adjust one or more of the optical characteristics of the pump beam to cause the pump beam to excite a second set of materials of the plurality of materials that is different from the first set of materials; and
pump the all-optical switch with the adjusted pump beam to induce the adjustment to the probe beam in a second response time.
